(19) United States
(12) Patent Application Publication
(10) Pub. No.: US 2007/0251462 A1
(43) Pub. Date: Nov. 1, 2007

(54) LIVESTOCK TRANSPORTATION SYSTEM AND COVER

(76) Inventors: Kurt Harris, Malta, ID (US); Todd Harris, Malta, ID (US)

Correspondence Address: ADVANTIA LAW GROUP, 9035 SOUTH 1300 EAST, SUITE 200, SANDY, UT, 84094, US

(21) Appl. No.: 11/279,427

(22) Filed: Apr. 12, 2006

(51) Int. Cl. B60P 3/04

(52) U.S. Cl. 119/403

(57) ABSTRACT

A livestock transportation system and cover for protecting transported livestock. The system includes a vehicle and a cover. The vehicle receives an animal and includes a side wall and a plurality of ventilation apertures disposed in an array through the side wall. The cover includes an elongated planar member disposed over and substantially covering the plurality of ventilation apertures; a first end portion; a second end portion; a first coupling member coupled to the first end portion and coupleable to the vehicle; and a second coupling member coupled to the second end portion and coupleable to the vehicle. The elongated planar member is a flexible fabric. The first coupling member includes a ratcheting cinch device configured to tighten a coupling between the first end portion and the vehicle. The first coupling member includes a hook coupleable to the vehicle. There is a rod member coupled to the elongated member.

### BACKGROUND OF THE INVENTION

1. Field of the Invention

The present invention relates to a livestock transportation system and cover, specifically, a device for covering ventilation holes in cattle transport trailers during cold weather conditions.

2. Description of the Related Art

In livestock transportation, it is vital to maintain a proper environment for the livestock. Typical concerns include: providing adequate fresh air and appropriate temperature control. It is generally unsatisfactory to provide a plurality of transportation trailers as they may be expensive and occupy a great deal of space. Accordingly, trailers/cars are typically outfitted with a great plurality of large apertures through which air may flow, thereby keeping the interior of the trailer cool and aerated. Further, these apertures reduce the total weight of the trailer, thereby enhancing fuel economy and impact on the road.

Seasonal variations of outside temperature often require operators of transport trailers to alter the trailer to reduce air flow. Accordingly, the general practice in the industry is to use specially shaped plugs to individually plug desired apertures. It may take a crew of two people a full day to properly plug the holes of a trailer in preparation for a cold season.

Accordingly, attempts have been made at providing enhanced trailers and trailer systems. The following examples of attempts to solve problems in shipping livestock. These patents/applications are hereby incorporated by reference herein.

U.S. Patent/Application No. 425,790 by Herman discloses: thc combination, in a stock-car, of a central row of posts, having gates hinged thereto, a longitudinal foot-hoard, arranged upon the top of the row of posts, and braces, extending therefrom to the roof of the car.

U.S. Patent/Application No. 121,212 by Stark et al. discloses: the employment of spring-buffers; in the construction and arrangement of the partition doors; in the construction and arrangement of the devices for feeding and watering; in movable and adjustable panels for the purpose of closing either or all the sides of the car in cold and stormy weather; and in the combination and arrangement of its several parts.

U.S. Patent/Application No. 232,90 by Montgomery discloses: in a stock-car, the upright or wall posts permanently secured to the outer side of the sills or floor frame bars by means of the metal socket-pieces, whereby greater strength is attained and an enclosed space or car-room of greater dimensions is secured than would be practicable by the usual construction.

U.S. Patent/Application No. 3,530,830 by Smith discloses: a relatively large rectangular container is used for shipping livestock, such as animals and poultry, by truck, railroad ear or marine vessels. Opposite sides of the shipping container are provided with vertically spaced parallel cleats secured against the side walls to selectively engage and support horizontal partitions. When the upper parallel members are used, the support extending across the container form an upper compartment in which may be arranged a bale of straw for supplying bedding to animals therebelow. When smaller animals or poultry are to be shipped, the transverse support may rest upon the lower longitudinal members to divide the containers into upper and lower compartments to increase the shipping capacity of the container.

Previous attempts at solving problems associated with transporting livestock often fail to properly provide for needs of users and/or livestock wherein they may be expensive, heavy, difficult to install, difficult to implement, too large, slow to install, etc.

What is needed is a livestock transportation system and/or cover that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available livestock transportation covers. Accordingly, the present invention has been developed to provide a livestock transportation cover.

In one embodiment of the invention there is a livestock transportation system for protecting transported livestock. The system may include a vehicle and/or a cover. The vehicle may be configured to receive an animal and may include a side wall and/or a plurality of ventilation apertures disposed in an array through the side wall. The cover may include an elongated planar member disposed over and substantially covering the plurality of ventilation apertures; a first end portion; a second end portion; a first coupling member coupled to the first end portion and coupleable to the vehicle; and/or a second coupling member coupled to the second end portion and coupleable to the vehicle.

The elongated planar member may include a flexible fabric. The first coupling member may include a ratcheting cinch device configured to tighten a coupling between the first end portion and the vehicle. The first coupling member may include a hook and/or the vehicle further may include a hook aperture configured to receive the hook. The first end portion may include a rod member coupled to the elongated member and/or substantially orthogonal thereto, wherein the first coupling member may be attached to the rod member. The plurality of ventilation apertures may be disposed in a vertical array and/or the elongated member may be coupled near a top of the vehicle and/or near a bottom of the vehicle, thereby spanning the vertical array. The elongated member may be rectangular.

In another embodiment of the invention there may be a livestock transportation cover device for protecting transported livestock. The device may include an elongated planar member, a first coupling member, and a second coupling member. The elongated planar member may be substantially impermeable to air and may include a first end portion and a second end portion. The first coupling member may be coupled to the first end portion and/or may include a coupling device configured to removably couple to another object. The second coupling member may be coupled to the second end portion and/or may include a coupling device configured to removably couple to another object.

The first coupling member may include a ratcheting cinch device configured to tighten a coupling between the first end portion and the vehicle. The elongated planar member may include a flexible fabric. The first coupling member may include a hook. The first end portion may include a rod member that may be coupled to the elongated member and/or substantially orthogonal thereto, wherein the first coupling member may be attached to the rod member. The elongated member may be rectangular.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF TH-E DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of a livestock transportation system according to one embodiment of the invention;

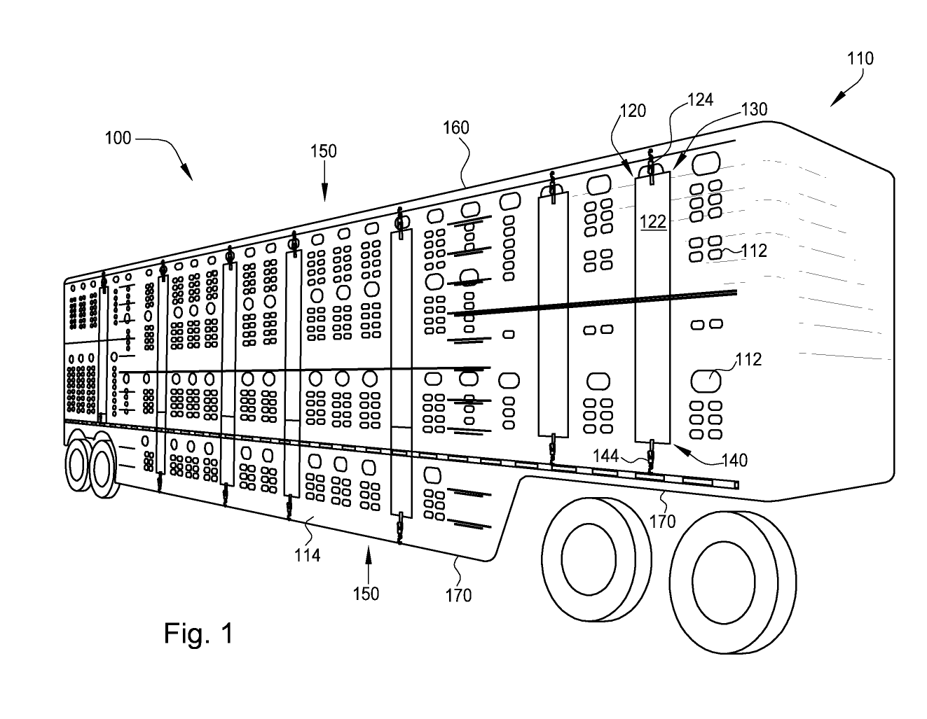

FIG. 2 illustrates a plan view of two ends of a livestock transportation cover according to one embodiment of the invention; and

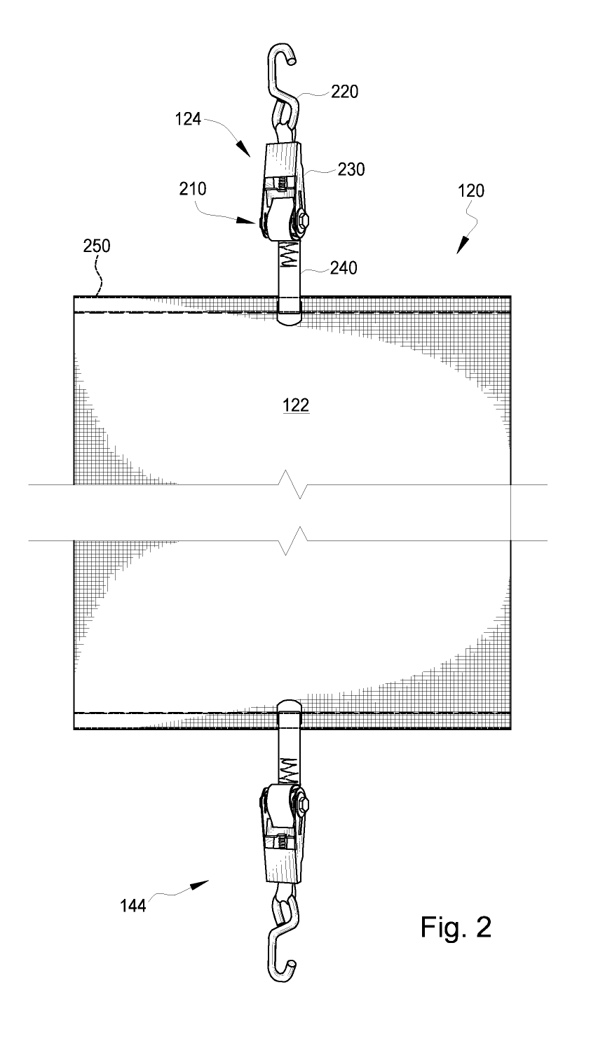

FIG. 3 illustrates a perspective view of a coupling member at an end portion of a livestock transportation cover according to one embodiment of the invention.

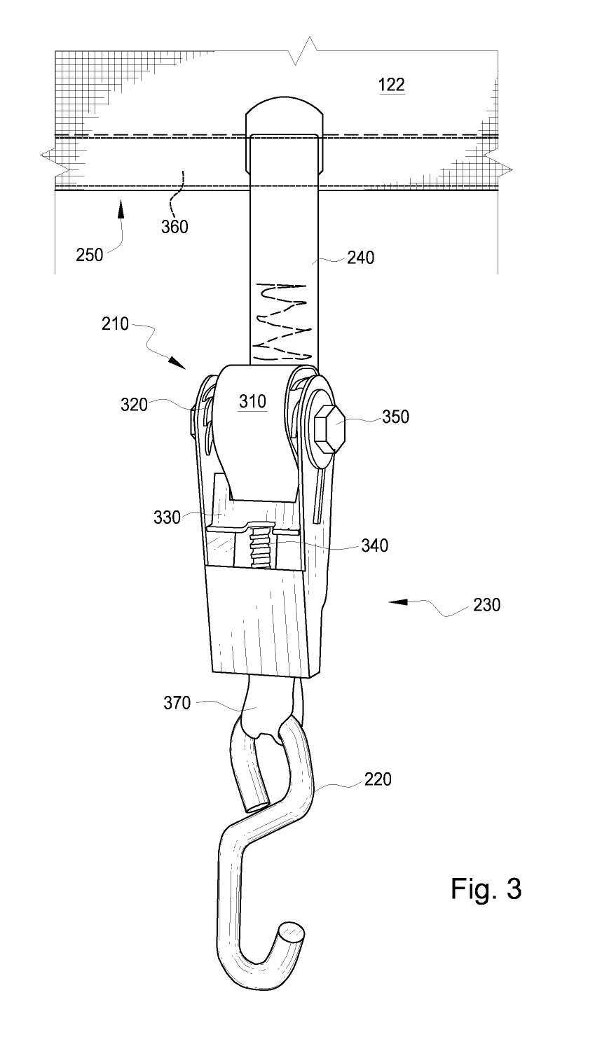

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Looking to the figures, there is shown a livestock transportation system 100 for protecting transported livestock. The illustrated system 100 includes a vehicle 110 and a cover 120. Thereby a vehicle 110, such as a trailer or car used in the transportation of livestock, may be advantageously alterable to incrementally provide varying levels of protection for livestock transported therein. There may be one or more vertical arrays 150 of apertures 112 that may be covered, thereby substantially restricting airflow therethrough. Where airflow is substantially restricted, insulation properties of the vehicle 111 are perceivably enhanced, especially during travel in cold weather conditions. Further, as a single cover 120 may substantially restrict airflow through a great number of apertures 112, such adjustments may be made quickly and easily when compared to other methods.

The illustrated vehicle 110 is configured to receive an animal(s) and includes a side wall 114 and a plurality of ventilation apertures 112 disposed in an array through the side wall 114. The side wall 114 may be planar or may be curved. There may be a plurality of side walls 114. The illustrated apertures 112 include apertures of all sizes. While a particular configuration of apertures 112 is shown in the drawings, it is understood that the variety of configurations of apertures including longitudinal arrays is nearly infinite, and accordingly, so is the variety of modes of practicing the invention. Further, aperture sizes may vary infinitely as well within reasonable bounds as would be understood by one skilled in the art after becoming familiar with the present invention.

The illustrated cover 120 includes an elongated planar member 122 disposed over and substantially covering the plurality of ventilation apertures 112; a first end portion 130; a second end portion 140; a first coupling member 124 coupled to the first end portion 130 and coupleable to the vehicle 110; and a second coupling member 144 coupled to the second end portion 140 and coupleable to the vehicle 110.

The illustrated elongated planar member 122 includes a flexible fabric. Accordingly, the planar member 122 may be advantageously rolled or otherwise stored in a configuration having a smaller maximum profile. Further, the material may receive tension, such as from opposing ends and thereby be drawn tight across the array of apertures 150. The material may be substantially impermeable to air, such as with a canvas material, such as those used for tarps, tents, rugged clothing, etc.

The illustrated first coupling member 124 includes a ratcheting cinch device 210 configured to tighten a coupling between the first end portion 130 and the vehicle 110. The ratcheting cinch device includes a roller having curved teeth 320 configured to rotatably interconnect in a single rotational direction with a spring 340 loaded restrictor 330 configured to permit rotational motion of the roller in a direction corresponding with reducing an effective length of a strap 240 as portions of the strap are coiled around the roller 310. There is also shown a turning member 350 configured to facilitate tightening of the roller. In one example the turning member 350 is shaped to receive a lever arm, in another example the turning member 350 may include an integral fold-out lever arm.

The illustrated first coupling member 124 further includes a hook 220 receivable by the vehicle 110 through a hook aperture or lip configured to receive a hook 220. Accordingly, the hooks 220 may be coupled to the vehicle 110 and the ratcheting cinch device 210 may be manipulated to tighten the cover 120 in place. Advantageously, the cover 120 is quickly, easily, and securely installed over a plurality of apertures 112.

The illustrated first end portion 130 includes a rod member 360 coupled to the elongated planar member 122 (disposed in a pocket 250 formed by a folded portion of the first end portion 130 that is attached to itself) and substantially orthogonal thereto. The illustrated first coupling member 124 is attached to the rod member 360, whereby tension in the first coupling member 124 is distributed substantially evenly over the first end portion 130, thereby enhancing the restriction of airflow and defocusing stress, thereby enhancing product life. The illustrated plurality of ventilation apertures 112 are disposed in a vertical array 150 and the elongated planar member 122 is coupled near a top 160 of the vehicle 110 and near a bottom 170 of the vehicle 110, thereby spanning the vertical array 150. The illustrated elongated member 122 is rectangular.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the illustrated elongated member is rectangular, other shapes are envisioned, such as ellipses, irregular shapes, etc. that are capable of covering a plurality of apertures.

Additionally, although the figures illustrate covers sized to cover a particular type of array, it is envisioned that the covers may be wider and/or narrower than shown in the drawings. It is expected that there could be numerous variations of the design of this invention.

Finally, it is envisioned that the components of the device may be constructed of a variety of materials, including but not limited to woven fibers, non-woven fibers, metal, composite, ceramic, plant-products, plastics, and combinations thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manna of operation, assembly and use may be made, without departing from the principles and concepts of the invention as set forth in the claims.

What is claimed is:

1. A livestock transportation system for protecting transported livestock, comprising:
a) a vehicle configured to receive an animal, the vehicle including:
a1) a side wall; and
a2) a plurality of ventilation apertures disposed in an array through the side wall; and
b) a cover disposed over the plurality of ventilation apertures, including:
b1) an elongated planar member disposed over and substantially covering the plurality of ventilation apertures, the elongated planar member having:
b2) a first end portion;
b3) a second end portion;
b4) a first coupling member coupled to the first end portion and coupleable to the vehicle; and
b5) a second coupling member coupled to the second end portion and coupleable to the vehicle.

2. The livestock transportation system of claim 1, wherein the elongated planar member further comprises a flexible fabric.

3. The livestock transportation system of claim 1, wherein the first coupling member further comprises a ratcheting cinch device configured to tighten a coupling between the first end portion and the vehicle.

4. The livestock transportation system of claim 1, wherein the first coupling member comprises a hook and the vehicle further comprises a hook aperture configured to receive the hook.

5. The livestock transportation system of claim 1, wherein the first end portion comprises a rod member coupled to the elongated member and substantially orthogonal thereto, wherein the first coupling member is attached to the rod member.

6. The livestock transportation system of claim 1, wherein the plurality of ventilation apertures is disposed in a vertical array and the elongated member is coupled near a top of the vehicle and near a bottom of the vehicle, thereby spanning the vertical array.

7. The livestock transportation system of claim 1, wherein the elongated member is rectangular.

8. A livestock transportation cover device for protecting transported livestock, comprising:
a) an elongated planar member substantially impermeable to air, having:
a1) a first end portion; and
a2) a second end portion;
b) a first coupling member coupled to the first end portion and including a coupling device configured to removably couple to another object; and
c) a second coupling member coupled to the second end portion and including a coupling device configured to removably couple to another object.

9. The livestock transportation cover device of claim 8, wherein the first coupling member further comprises a ratcheting cinch device configured to tighten a coupling between the first end portion and the vehicle.

10. The livestock transportation cover device of claim 9, wherein the elongated planar member further comprises a flexible fabric.

11. The livestock transportation cover device of claim 10, wherein the first coupling member comprises a hook.

12. The livestock transportation cover device of claim 11, wherein the first end portion comprises a rod member coupled to the elongated member and substantially orthogonal thereto, wherein the first coupling member is attached to the rod member.

13. The livestock transportation cover device of claim 12, wherein the elongated member is rectangular.

14. A livestock transportation cover device for protecting transported livestock, comprising:
a) an elongated rectangular planar member of flexible fabric substantially impermeable to air, having:
a1) a first end portion including a rod member coupled to the elongated member and substantially orthogonal thereto, wherein the first coupling member is attached to the rod member; and
a2) a second end portion;
b) a first coupling member coupled to the first end portion and including:
b1) a hook; and
b2) a ratcheting cinch device configured to tighten a coupling; and
c) a second coupling member coupled to the second end portion and including a coupling device configured to removably couple to another object.
